(19) United States
(12) Patent Application Publication
(10) Pub. No.: US 2011/0185434 A1
(43) Pub. Date: Jul. 28, 2011

(54) WEB INFORMATION SCRAPING PROTECTION

(75) Inventors: Rickard Wetterström, Farsta (SE); Stefan Andersson, Oxelosund (SE)

(73) Assignee: STARTA EGET BOXEN 10516 AB, Farsta (SE)

(21) Appl. No.: 13/000,157

(22) PCT Filed: Jun. 18, 2009
(86) PCT No.: PCT/SE09/50770

§ 371 Date: Mar. 18, 2011

(30) Foreign Application Priority Data
Jun. 19, 2008 (SE) 0801457-3

(51) Int. Cl. G06F 17/30

(52) U.S. Cl. 726/26

(57) ABSTRACT

A method and a filter element for preventing scraping/clipping of the information content of a database used for providing a website with data information. When a data record set from the database has been received, the filter splits all elements/fields of the data record set in a predetermined way into cells and a sortid is provided. Each cell is encoded into a markup language, wherein location information in the cell is used for generating a location value. The encoded cells are sorted into a file to establish a file, e.g. web page, wherein the encoded data cells are distributed in an arbitrary order.

### TECHNICAL FIELD

The present invention relates to anti-scraping technologies. More exactly, the present invention provides a filter device and a method for preventing scraping.

### BACKGROUND

The World Wide Web, even called Internet, offers several different opportunities to the world community in relation to business transactions, sharing of information, communication, etc.

It has been popular to sell goods and merchandise, new or second-hand, over the Web. Similar to post-order catalogues, the goods are often displayed with an image, a short presentation and a price. Other form of collected information are also presented on the Web. A lot of time, efforts and money are spent for collecting, organizing, and producing a nice looking web site presenting the objects for sale. The handling of and management of such web sites are often expensive. From a business view, it is important that the cost in time and money will pay off.

Right or wrong, information that is published on the Internet is regarded as free to use by many Internet users. A growing business is to collect data about similar objects or services being offered for sale on different web sites, and publish said data about the objects, e.g. name, brand, size, colour, price, etc., on a “parasitic web site” offering a possibility to compare the price on similar products. In some cases, a customer will be linked from the parasitic web site to the correct web site that in reality is offering the product or collected information by clicking on a link, e.g. in form of an icon in connection with the special object of interest. In other cases, the information from web sites are offered for sale on parasitic web sites. Web sites are often financed by commercial advertising based on registered visitor numbers. This kind of information gathering from other sites will cause that the number of visitors to the sites from where the information has been copied will decrease. Further, collecting and organizing the data on the web site means a lot of costs as it is performed manually by people that is paid. Some kind of web sites are therefore often very expensive to run. The parasitic web sites owners takes advantage of other peoples work and efforts. The kind of web sites that have the described problem are for example:
Different kind of catalogue services;
Dating sites;
Estate business sites;
Betting and bookmaking sites.

The terms for this kind of activities are scraping, web scraping, screen scraping, data scraping or web clipping, and said activities have become a eve growing problem. The most often used scraping method is to analyze HTML-code on a page, connect a scraping tool to specific parts in the code and then let an automatised process copy data from the page. The data is often very well-structured and it will be possible to copy special data by identifying a pattern in where different kind of data is presented. The copied data information is added to a database, which will be possible to update with new data information as soon as a watched web site is updated. The data information could then be used for making own revenue as described above.

It might be considered to be simple to protect a web site against scraping. There are a few different known anti-scraping methods, but said methods introduce different limitations to the services that are supposed to be provided by a web site.

One known method is to limit the number of searches that each visiting IP-address (user, client) within a pre-defined time period. One drawback with this kind of anti-scraping method is that a lot of users are hiding behind proxy-servers or are members in a big corporate network or VPN. There is a risk that this method will deny visitors entrance to the web site or access to requested information due to the fact that the quote of visits by their used IP-address is already fulfilled.

Another known method is called “Captcha”, and it requires a visitor to manually enter a code in a document field that is presented on the web site by an image. This method prevents in many cases that automatised processes acquire data from the database as only the human eye and intellect is able to interpret the presented information and the fact that the visitor manually writes the code for being allowed access to the information in the database. One drawback with the method is that some visitors consider the code entering procedure as tiresome and laborious as it has to be performed for every visit and search. Scraping is not prevented as it is possible to force the obstacle by using a combination of “hiding” and an automatised process.

Another anti-scraping method is to supervise the traffic on the net by means of a security system. The system is configured to indicate and alarm if certain criteria is fulfilled. Each indication is manually analyzed, and if undesired net traffic is identified, said traffic is possible to prevent from access to the site. The drawback is that the method is complicated and expensive.

From the U.S. Pat. No. 6,938,170 B1 is known a system and methods for preventing automated crawler access to web-based data sources using a dynamic data transcoding scheme. A transcoding proxy is situated between the web server to be protected and a remote user's web browser and crawler. The web server generates and sends web pages having original web form to the transcoding proxy containing a web page manipulator. Said web page manipulator is capable of using a number of transcoding techniques for generating and distributing a manipulated web form of the web page to the remote Internet user. One of the transcoding techniques is to amend the structure of the original web form by using structure inserts. Such inserts have the drawback that they may distort the display of the web page on the user's computer screen.

A problem to be solved is therefore to offer more cost-effective and easier means and methods for protecting a web site and its information against scraping without introducing limitation and drawbacks such as those described above.

### SUMMARY

The object of the present invention is to offer protection of a web site and its information against scraping without introducing un-necessary limitations and drawbacks.

This object is achieved by gathering the requested structured data record from a database to be sent to a user in an intermediate stage in the web server handling the user's search and divide the data record into data containers, or cells, which are given an unique sorting identity, hereafter called sortid. Each cell's sortid is encrypted and sorted by means of said encrypted sortid's to establish a new unstructured data record in a file, or document, to be sent to the requesting client/user. Said encrypted sortid's may be generated by means of a random number generator.

When an automatised scraping process is performed to acquire the hidden data information, said data information is totally unstructured for the process, and any pattern of the received data information will not be possible to identify.

In more detail, the present invention provides a method for preventing scraping of the information content of a database used for providing a website with data information. The method comprises the steps of:
receiving a data record set from the database;
splitting all elements/fields of the data record set in a predetermined way into cells;
encoding each cell into a Markup Language wherein the location information in the cell is used for generating a visual location value;
sorting the encoded cells into a file to establish a file wherein the encoded data cells is distributed in an arbitrary order.

Further, the present invention relates to a filter or filtering means for preventing scraping of the information content of a database used for providing a website with data information. The filter means comprises means for receiving a data record set from the database, means for splitting all elements/fields of the data record set in a predetermined way into cells. The filter means also comprises means for encoding each cell into Markup Language, wherein the location/position information in the cell is used for generating a location value, and means for sorting the encoded cells into a file to establish a file wherein the encoded data cells is distributed in an arbitrary order.

The filter means or filtering means and method may be implemented in a number of ways, e.g. as software executed by processing means, hardware, etc.

A computer readable medium, encoded with software code means for performing the steps according to the invention when executed by a computer, is also provided.

The present invention may also be regarded as a method for sending or communicating a scraping proof file of data records from a data base to a requesting client.

One advantage with the method is that it is very simple to adjust to different kind of data information, databases and web sites and/or platforms. Further one advantage is that an ordinary web browser will be able to read and create a non-distorted web page on a computer screen/display without any modifications of a Internet user's ordinary web browser. Another advantage with this method is that it provide a number of possibilities to alter the source code and scramble the order of the data objects in the output of the data set in a file, web page, etc.

### BRIEF DESCRIPTION OF THE DRAWINGS

The foregoing, and other, objects, features and advantages of the present invention will be more readily understood upon reading the following detailed description in conjunction with the drawings in which:

FIG. 1 is a block diagram illustrating an overview of the system architecture wherein the present invention is provided.

FIG. 2 is a signalling scheme illustrating the prior art.

FIG. 3 is a signalling scheme illustrating the present invention.

FIG. 4 is a flow chart illustrating a method according to the present invention.

FIG. 5a is a block diagram schematically showing a data record set.

FIG. 5b is a block diagram illustrating an example of a data cell.

FIG. 5c is a block diagram illustrating an example of a HTML coded cell.

FIG. 5d is a block diagram showing an exemplified web page comprising HTML coded cells.

FIG. 6 is a block diagram illustrating an anti-scraping processed table.

FIG. 7 is a block diagram illustrating an anti-scraping filter design according to the invention.

### DETAILED DESCRIPTION

In the following description, for purposes of explanation and not limitation, specific details are set forth, such as particular circuits, circuit components, techniques, etc. in order to provide a thorough understanding of the present invention. However, it will be apparent to one skilled in the art that the present invention may be practiced and other embodiments that depart from these specific details. In other instances, detailed descriptions of well known methods, devices, and circuits are omitted so as not to obscure the description of the present invention with unnecessary detail.

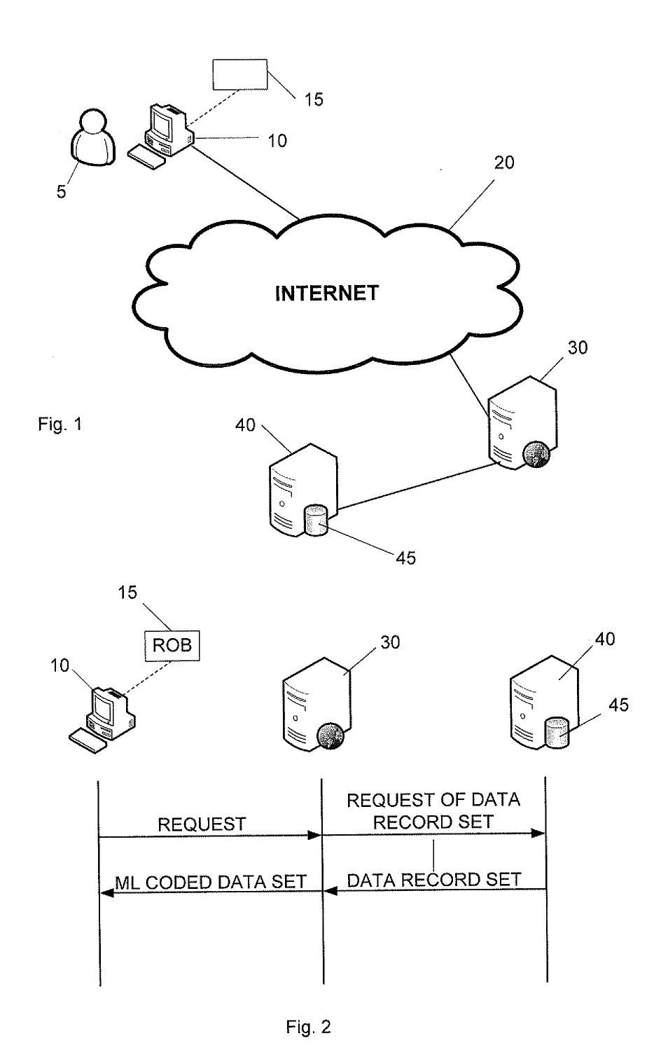

Prior art will now be described with reference to FIGS. 1 and 2. FIG. 1 is a block diagram illustrating an overview of the system architecture wherein the present invention is provided. FIG. 2 is a signalling scheme illustrating the prior art process for requesting data information from a web site. A web site is a collection of electronically defined pages generally formatted in markup language, e.g. HTML (Hypertext Markup Language), XHTML (Extensible Hypertext Markup Language), WML (Wireless Markup Language), XML (Extensible Markup Language), etc., that may comprise text, graphic images, and multimedia effects such as sound files, video and/or animation files. A Web page is a document, typically written in HTML, that is almost always accessible via HTTP, a protocol that transfers information from the Web server to display in the user's Web browser.

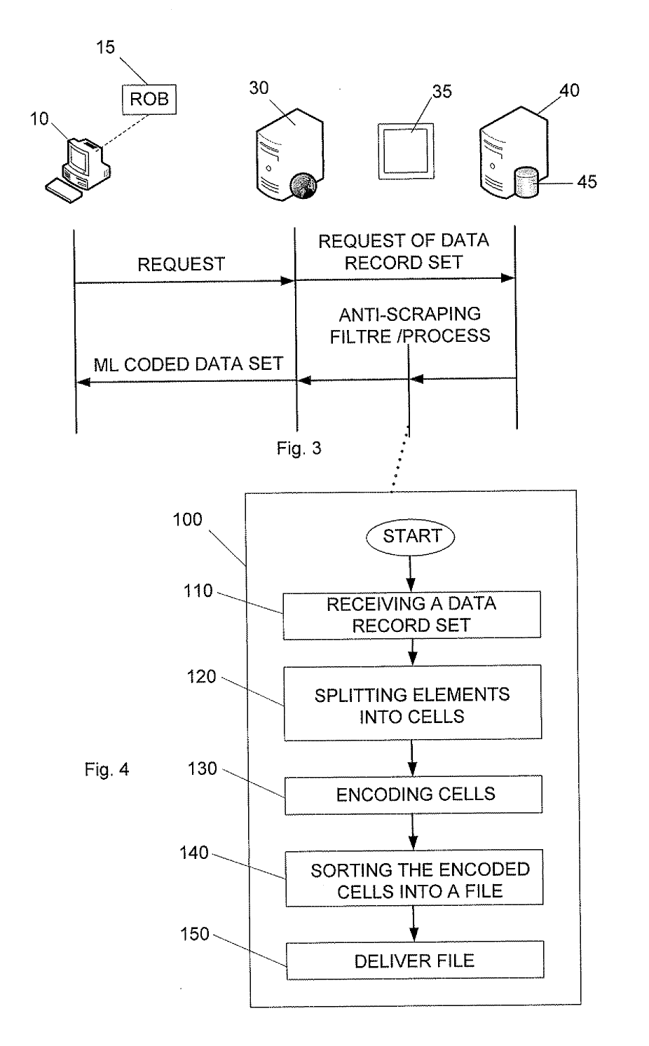

A person 5 and/or a scraping software or tool 15, here denoted as robot, uses the client computer 10 for navigating from web site to web site for information provided on the internet 20. The client computer sends a request to a web server 30. The web server 30 uses a script for receiving the clients request and the server 30 sends a request of data record set to selected databases (a database is a structured collection of records or data). In FIG. 2 and in FIG. 3 a database is illustrated as a database server 40 comprising a database 45, wherein the request script identifies and copy requested data thereby producing a data record set. A web site may in this case be regarded as comprising a web server 30 and at least one database 45. The web server 30 receives a structured selection of posts and fields from database 45. The web server 30 transforms by means of a script the data information to structured Markup language code, e.g. HTML-code, which data information is sent to the client computer 10 that receives the data information for storing and/or displaying the data information as a web page. The robot 15 in the client computer 10 processes the data information and interprets the structured Markup language code by using scraping or clipping, which will find the interesting data elements of the web page. The robot will be able to automatically process a great number of interesting web sites and web pages for certain data information, which could be used for producing a new web site containing collected data information from said great number of web sites.

FIG. 3 is a signalling scheme illustrating the present invention. The object of the invention is achieved by an anti-scraping filter means 35 and process. The requested structured data record, i.e. data record set, from a file, or document, to be sent to a user is gathered in an intermediate stage between the web server 30 handling the user's search and the database 45 A Web page is a document, typically written in HTML, that is almost always accessible via HTTP, a protocol that transfers information from the Web server to display in the user's Web browser. The means 35 and process divides the data record set into data containers, here called cells, which are given a unique sortid. Each cells sortid is encrypted and sorted by means of said encrypted sortid to establish a new unstructured data set in a file, or document, to be sent to the requesting client/user. Said encrypted sortid may be generated by means of a random number generator. The anti-scraping filter is possible to insert for use anywhere between the database 45 and where the web page, file, document, etc., to be sent to the client computer 10, is generated.

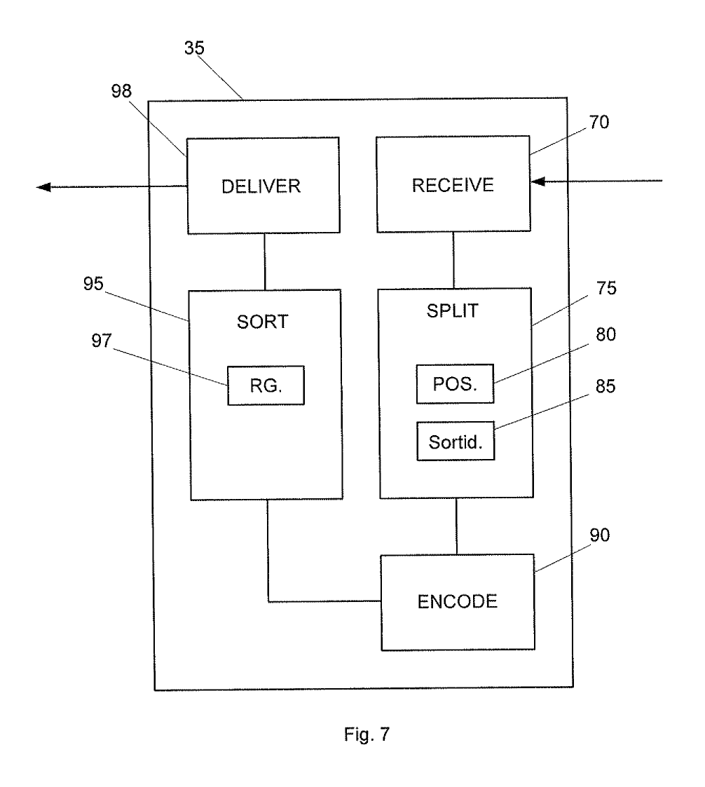

The anti-scraping filter will be described in more detail further down in connection with FIG. 7.

When an automatised scraping process is performed to acquire the hidden data information, said data information is totally unstructured for the process, and any pattern of the received data information will not be possible to identify for a scraping tool, such as a robot. However, an ordinary Web browser will be able to identify, read and organize the data information by means of visual location data, also herein denoted visual location value or location information. The invented method ad filter will prevent scraping of the information content of the database and the file, but result in a correct visualization of the file on displaying means, such as a computer screen. There are a large number of ways (methods) of presenting the visualisation that are not included in the invention, but depending on the invention. These methods can be altered and will make it even harder for a scraping tool to organize the data in the received data information.

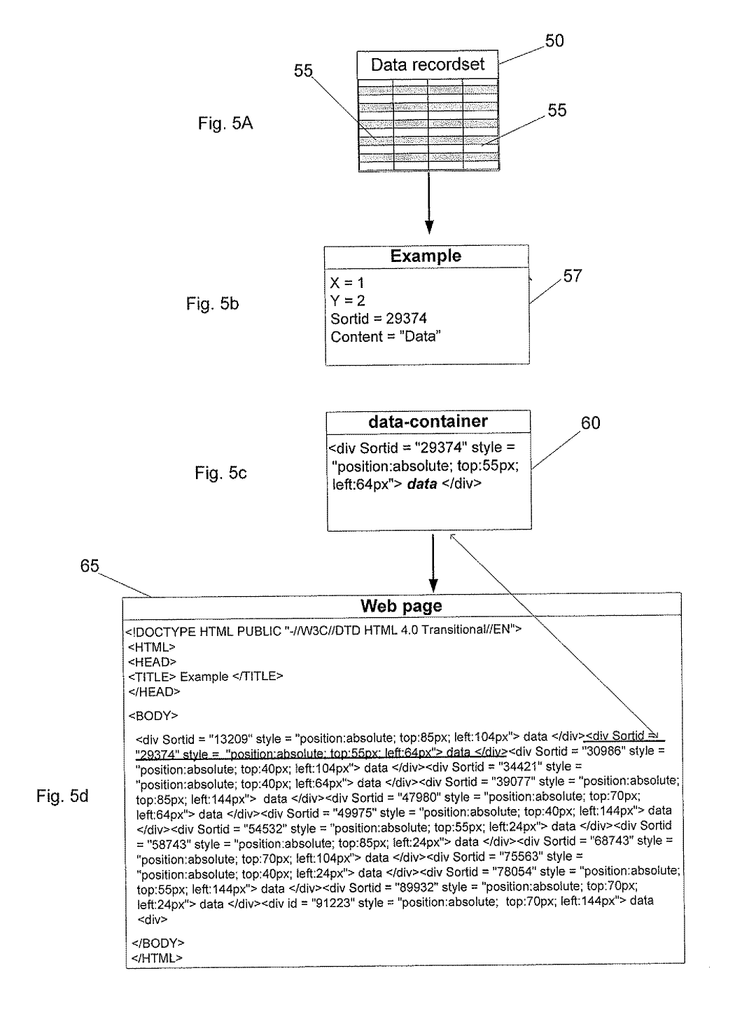

FIG. 4 is a flowchart illustrating the invented method 100, which now will be described in more detail with references to said flowchart. The web server 30 receives via a request of data record set from the database 45 a structured selection of posts and fields, i.e. a data record set or a file, to the web server. The first step of the present invented method, step 110, is to receive said data record set in the web server. The next step is not to produce a HTML-coded web page for sending to the requesting client. According to the invented method, the next step, step 120, is to split all data elements, or in some case data fields, of the data record set in a predetermined way into cells by means of a splitting algorithm in a server script. One data element of a data record set is illustrated in FIG. 5a. Each cell is therefore containing an element or field with a piece of data information, here denoted as cell content. The cell size may be chosen dynamically to an appropriate size. Each cell is also provided with record set location information, e.g. horizontal and vertical coordinates, ordinal number, etc., defining the place of the data content in each cell, respectively. An example of a cell is illustrated in FIG. 5b. In the splitting step, step 120, each cell is also given an sortid that preferably is generated by means of a random number generator.

In step 130, the encoding step, each cell is encoded into a Markup Language, e.g. HTML, and the location (or position) information in the cell is used for generating a visual location value. The Markup Language encoded cell may be denoted a data container. A data container is illustrated in FIG. 5c. A datacontainer is “data” which is surrounded of some kind of markup language code, for example html and given an absolute visual position, for example top: 50 pixels and left: 50 pixels.

Then, in the sorting step, step 140, the data containers are sorted into a file, e.g. a web page or document, in an unstructured manor, preferably using some kind of random generator by means of the unique sortid.

Finally, in step 150, the web server will address and deliver the file to the requesting client computer 10 (see FIG. 3) in question.

When the user 5 by means of the client, such as a web browser, is opening the file, the unstructured placement of each data container is not causing any problem for the displaying of the file as a web page. The web browser will ignore the datacontainers structural placement in the code which is based upon it's sortid and it will visually sort the data containers of the received file, e.g. web page, according to the visual location information. Visually the information of the web page is presented in the same order that elements and fields originally were associated and distributed in the originally data record set received by the data base server. However, a robot operating with a scraping software requires structured data information to be able to interpret the content and to be able to visualise the data information. Thus, the scraping robot will be prohibited to use a file that has been generated by means of the above described anti-scraping process.

In the above-described embodiment, the splitting step 120 involves a step of providing each cell with a record set of location information for defining the place of the data content in a file, document, web page, database, etc. In another embodiment, the step of providing each cell with a record set of location information for defining the place of the data content in a file, document, web page, database, etc., is following the splitting step 120.

In the above-described embodiment, the splitting step 120 also involves a step of giving each cell a unique sortid. In another embodiment, the sortid step wherein each cell is given a unique sortid may be a step that is performed after the splitting step 120.

The invention will now be presented in more details with reference to FIGS. 5a-5d.

FIG. 5a is a block diagram schematically showing a data record set. In this example, the data record set is a data table comprising data elements located in a matrix consisting of rows and columns. The position of each element in the matrix is possible to define by means of a column coordinate, i.e. horizontal parameter, and a row coordinate, i.e. vertical parameter. Therefore, either during, or after, splitting the data set into a set of data cells by means of a splitting algorithm, each data element is provided with an sortid, with position data and the data content of the element.

FIG. 5b is a block diagram illustrating an example of such a data cell. Here, X and Y are the position information coordinates, wherein X is defining which column the element is situated, and Y is stating from which of the rows of the matrix the element is collected. The starting position, or origin, of the position coordinate information may be chosen arbitrary in a suitable way. The sortid may as mentioned be generated by means of a random number generator. When sorting the cells into a file by means of the sortid's, adjacent cells in the data record set will be mixed with other cells and if the number of cells is big enough (e.g. >50 cells), the probability for adjacent cells to be positioned in the same positions in the new generated data record set is very small, and said probability will decrease with increasing number of data cells.

In the next step, the encoding step, each cell is encoded into a Markup Language, e.g. HTML, and the location (position) information in the cell is used for generating a visual location value, defined according to a pixel position system in the visualisation of the web page in which the data content is presented. The Markup Language encoded cell may be denoted a data container.

FIG. 5c is a block diagram illustrating an example of a Markup Language encoded cell. In said data container, div sortid=“29374” is the sorting identity of the cell, style=“position: absolute; top: 55px; left: 64px” is the visual location data. Said data container heading. even called cell heading, is followed by the payload data, i.e. the element data content. The sortid which is displayed in the datacontainer is only for demonstration purposes, it is not recommended to show the sortid in the code sent to the client browser for security reasons.

FIG. 5d is a block diagram showing an exemplified web page comprising Markup Language coded cells which position order in relation to the original data record set has been changed. The position of the data container illustrated in FIG. 5c is indicated in the web site.

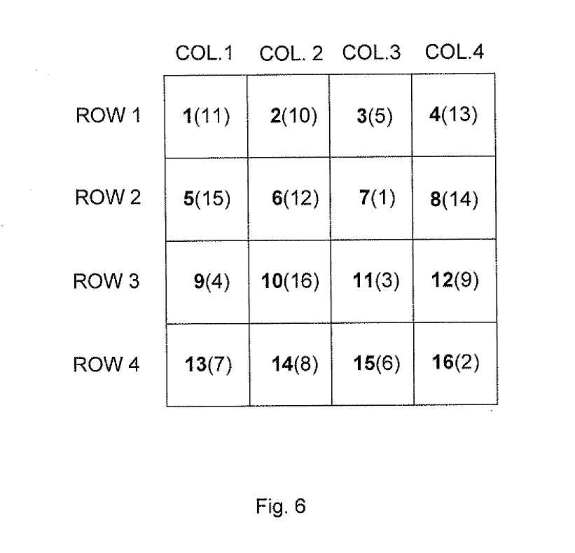

FIG. 6 is a block diagram illustrating an anti-scraping processed table matrix. In this example, the data set is a data table comprising data containers in a matrix consisting of rows and columns. The position of each element in the matrix is possible to define by means of a serial order number in a vector, wherein the first post of the vector is number 1, the next post in the adjacent column in the same column is number 2, and so on. The order number in extra bold type indicates the visual position of a data container in the matrix vector according to said order system. The order number within the parenthesis indicates the original order of the data record set received from the data base server.

For the purpose to prevent scraping of the information content of a database used for providing a website with data information, the present invention also provides an anti-scraping filter.

FIG. 7 is a block diagram illustrating an anti-scraping filter design according to the invention. The filter and filtering components are controlled by a processing means.(not shown). The filter means 35 comprises means 70 for receiving a data record set from the database 45 (see FIG. 3). The data record set 50 (see FIG. 5a) is then handled by means 75 for splitting all elements/fields 55 (see FIG. 5a) of the data record set in a predetermined way into cells 57 (see FIG. 5b). The splitting may be performed by means of a splitting algorithm. Additionally, the splitting means comprises means 80 for providing each cell with record set location (position) information for defining the place of the data content and means 85 for giving each cell a unique sortid. Said unique sortid preferably is generated by means of a random number generator.

Further, the anti-scraping filter 35 comprises means 90 for encoding each cell into a Markup Language, e.g. HTML, wherein the location information in the cell is used for generating a location value for visualisation.

The filter means 35 is also provided with means 95 for sorting the encoded cells into a file to establish a file wherein the encoded data cells is distributed in an arbitrary order. A random generator 97 may be used for distributing the encoded cells into a file to establish a file, e.g. a web page, wherein the encoded data cells 60, data containers (see FIG. 5c) is distributed in an arbitrary order. Additionally, the filter means 35 may comprise means 98 for addressing the file and deliver the file, e.g. web page, for distribution to the client ordering the data record set from the web site.

In the above described embodiment of the invention, the filter means comprises means 80 for providing each cell with record set location information for defining the place of the data content, wherein said location providing means 80 is situated within the splitting means 75. In another embodiment, said location providing means 80 is placed after said splitting means 75.

In the above described embodiment of the invention, the filter means comprises means 85 for giving each cell a unique sortid, wherein said sortid means 85 is situated within the splitting means 75. In another embodiment, said means 85 is situated after said splitting means 75.

The invention may be implemented in digital electronically circuitry, or in computer hardware, firmware, software, or in combinations of them. Apparatus of the invention may be implemented in a computer program product tangibly embodied in a machine readable storage device for execution by a programmable processor; and method steps of the invention may be performed by a programmable processor executing a program of instructions to perform functions of the invention by operating on input data and generating output.

The invention may advantageously be implemented in one or more servers, computer programs or scripts that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language.

For the purpose, a computer readable medium is encoded with said software code means (program) for performing the steps according to the invented method when executed by a computer. In that way, the software code means is stored on a computer-readable carrier. Generally, a processing means, e.g. processor will receive software code means, e.g. instructions and data, from said computer-readable carrier, such as a read-only memory and/or a random access memory or other kind of storage devices suitable for tangibly embodying computer program instructions and data include all forms of non-volatile memory, including by way of example semiconductor memory devices, such as EPROM, EEPROM, and flash memory devices; magnetic disks such internal hard disks and removable disks; magneto-optical disks; and CD-ROM disks. Any of the foregoing may be supplemented by, or incorporated in, specially-designed ASICs (Application Specific Integrated Circuits).

A number of embodiments of the present invention have been described. The present invention may also be regarded as a method for sending a scraping proof file of data records from a data base to a requesting client. It will be understood that various modifications may be made without departing from the scope of the invention. Therefore, other implementations are within the scope of the following claims defining the invention.

1. A method for preventing scraping of the information content of a database used for providing a website with data information, wherein the method comprises the steps of:
receiving a data record set from the database;
splitting all elements/fields of the data record set in a predetermined way into cells;
encoding each cell into Markup Language, wherein the location information in the cell is used for generating a visual location value;
sorting the encoded cells, data containers, into a file to establish a file wherein the encoded data cells is distributed in an arbitrary order, thereby preventing scraping of the information content of the database and the file, but result in a correct visualization of the file on displaying means.

2. The method of claim 1, wherein the splitting step is implemented by means of a splitting algorithm.

3. The method of claim 1, wherein the splitting step either involves a step of providing each cell with a record set of location information for defining the place of the data content in a file, document, web page, database, or is followed by a step of providing each cell with a record set of location information for defining the place of the data content in a file, document, web page, or database.

4. The method of claim 1, wherein the splitting step either involves a step of giving each encoded cell a unique sorting identity, sortid, or is followed by a step wherein each encoded cell is given a unique sortid, which is used in the sorting step for creating an arbitrary order of the encoded cells in a file to be sent to a requesting client.

5. The method of claim 4, wherein the unique sortid preferably is generated by means of a random number generator.

6. The method of claim 1, wherein the sorting step involves the use of some kind of random generator for distributing the encoded cells into a file to establish a file wherein the encoded data cells is distributed in an arbitrary order.

7. The method of claim 1, wherein the file is addressed and delivered for distribution to the client ordering the data record set from the web site.

8. A filter means for preventing scraping of the information content of a database used for providing a website with data information, said means comprising means for receiving a data record set from the database, means for splitting all elements/fields of the data record set in a predetermined way into cells, means for encoding each cell into Markup Language, wherein the location information in the cell is used for generating a visual location value, and means for sorting the encoded cells, data containers, into a file to establish a file wherein the encoded data cells are distributed in an arbitrary order, thereby preventing scraping of the information content of the database and the file, but result in a correct visualization of the file on displaying means.

9. The filter means of claim 8, wherein the splitting means comprises a splitting algorithm.

10. The filter means of claim 8, wherein the filter means comprises means for providing each cell with record set location information for defining the place of the data content, wherein said location providing means is either situated within the splitting means or after said splitting means.

11. The filter means of claim 8, wherein the filter means comprises means for giving each cell a unique sortid, wherein said sortid means is either situated within the splitting means or after said splitting means.

12. The filter means of claim 11, wherein the unique sortid preferably is generated by means of a random number generator.

13. The filter means of claim 8, wherein the means for sorting comprises a random generator to distribute the encoded cells into a file to establish a file wherein the encoded data cells are distributed in an arbitrary order.

14. A computer readable medium encoded with software code means for performing the steps according to claim 1 when run on a computer.

15. The computer readable medium according to claim 14, wherein the software code means is stored on a computer-readable carrier.

16. The method of claim 2, wherein the splitting step either involves a step of providing each cell with a record set of location information for defining the place of the data content in a file, document, web page, database, or is followed by a step of providing each cell with a record set of location information for defining the place of the data content in a file, document, web page, or database.

17. The method of claim 2, wherein the splitting step either involves a step of giving each encoded cell a unique sorting identity, sortid, or is followed by a step wherein each encoded cell is given a unique sortid, which is used in the sorting step for creating an arbitrary order of the encoded cells in a file to be sent to a requesting client.

18. The method of claim 3, wherein the splitting step either involves a step of giving each encoded cell a unique sorting identity, sortid, or is followed by a step wherein each encoded cell is given a unique sortid, which is used in the sorting step for creating an arbitrary order of the encoded cells in a file to be sent to a requesting client.

19. The filter means of claim 9, wherein the filter means comprises means for providing each cell with record set location information for defining the place of the data content, wherein said location providing means is either situated within the splitting means or after said splitting means.

20. The filter means of claim 10, wherein the filter means comprises means for giving each cell a unique sortid, wherein said sortid means is either situated within the splitting means or after said splitting means.
